(19) United States
(12) Patent Application Publication
(10) Pub. No.: US 2015/0111984 A1
(43) Pub. Date: Apr. 23, 2015

(54) INSECT-REPELLENT, WATER-BASED, FIREPROOF VINYL-ACRYLIC THERMAL PAINT COMPRISING PHASE-CHANGE MATERIALS

(71) Applicant: Alberto Vargas San Jose, Guanajuato (MX)

(72) Inventor: Alberto Vargas San Jose, Guanajuato (MX)

(21) Appl. No.: 14/351,675

(22) PCT Filed: Oct. 14, 2011
(86) PCT No.: PCT/MX2011/000125

§ 371 Date: Dec. 11, 2014

(51) Int. Cl. C09D 5/18

(52) U.S. Cl. CPC C09D 5/18
USPC 523/122

(57) ABSTRACT

This remarkable invention provides: a vinyl-acrylic water base paint that contains encapsulated phase change materials of oleoresin from capsaicin or capsicum, derived directly from the placenta of the chili pepper. The paint also has fire-retardant properties, in one of its modes. The paint is also used to maintain the temperature of a closed enclosure, in a zone of temperature that depends on the components of phase change materials and where they can work in a range of temperatures suitable for zones of comfort and cooling areas, saving costs because of less use of air conditioning and heating equipment systems.

### INVENTION BACKGROUND AND FIELD

This invention relates to a thermal paint vinyl-acrylic aqueous base which includes storers with repellent characteristics phase change materials for insects.

There are in the paint market vinyl-acrylic paints that include phase change materials, there are also products with elements to avoid that certain insects settle on the surfaces on which these coatings are apply; However, to the inventors of this application best knowledge, there is no a vinyl-acrylic water base fireproof paint, that includes PCM particles among its components, meaning phase change materials that may achieve a repellent effect against insects. This paint may also include elements to combat bacteria and fungi in the area where it is applied.

In the field of products and processes that have characteristics of thermo activity, as the one we have been talking about, there are some inventions as developed by the University of Wisconsin in the year of 1990, which consisted in incorporating phase change materials to the building materials of constructions, such as screens and interior ceiling with plaster and external plaster coatings, achieving, therefore, to maintain temperatures of comfort and restricted the use of air conditioning equipment. The German firm Rubitherm has incorporated materials of phase change that it produces, to tables of wood fibers to be used as a floor or screens, also having a magnificent effect to prolong the desired temperature level, with decreased use of external sources of air conditioning, heating or air conditioning inside homes and buildings.

Besides the ones mentioned above, applications of phase change materials have also been made in other uses, such as leather seat covers, thermal clothing, containers to maintain hot food, containers to keep cold vaccines or organs for transplants, etc.

U.S. Pat. Nos. 6,251,970 and 6,387,482 Persiani et. al., refer to a coating of heat absorbent surface which has a plurality of micro capsules, being each one, a surrounded shell with an absorbent material of heat inside the cover and pasted to a substrate carrier and through which the microcapsules are dispersed. The heat absorbing materials is preferably a (PCM or MCF) phase change material and as examples are quoted: polyethylene, polypropylene, polywax and their combinations. The cover may be a metal such as copper or a polymer, the carrier it is cited as a mixture of sprayable polymer.

There is also the document JP 11246796, granted to Senoo Shinji et. al., which refers to a process for PCM powder coating that includes a film forming component. The coating powder for PCM contains, for example, a thermosetting resin and a hardener as the film forming component. It also refers to a steel plate with a film made with such coating.

It is also known the patent ES 2127121, which is considered as the closest prior art to this invention, and it refers to a concentrated emulsifiable vinyl inhibiting the synthesis of chitin of arthropod pests and allergen control granted to Mateo Herrero Maria Pilar, which differs from the present request in which the novel paint, specifically contains an additive called oleoresin of capsaicin or capsicum, derived directly from the placenta of the chili pepper, whose attribute in this application constitutes an innovation in the sense of attacking notably the sensory system of flying and crawling insects, through inhalation and burning produced by capsaicin with a level similar to the pungent pepper gas which contains also the transmitter agent.

In the paint with Inesfly 5A IGR insecticide, manufactured now by Kolmer, from Ma Pilar Mateo Herrero, the active material is Diazinon and Chlorpyrifos, plus others such as the A-cypermethrin and D-tetramethrin, or as PBO and Piriproxi can be found. All these are chemical insecticides agents. This painting inhibits and sterilizes mentioned arthropods females, while Enerpaint is the only repellent.

### OBJECTS OF THE INVENTION

It does not exist, in the state of the art paint vinyl-acrylic water base, paints that comprise two or more of the following desirable characteristics: capacity to maintain thermal stability within an enclosure by elements of phase change, and at the same time to be repellent to insects. Our paint can be optionally a bactericide and fungicide. In an additional modality paint may be fireproof.

Therefore, it is an object of this application to provide a vinyl-acrylic paint that is water base and that includes particles of phase change.

It is an additional object of this application to provide a vinyl-acrylic paint that is insects repellent.

It is an additional object of this application to provide a vinyl-acrylic paint that is repellent to insects and/or flame retardant.

Further on, it is an object of this invention to provide a vinyl-acrylic paint that has at least two of the following properties: be able to stabilize the temperature in a room within a certain range, for example 20 to 24° C. In the case of the air conditioning rooms this temperature is usually 23° C. to 24° C. In its formulation contains organic phase change materials such as fatty acids like, Lauric, Palmitic, Stearic and/or Myristic storers, as well as Paraffinic as the mixture of Hexadecane C₁₆H₃₄ with Octadecane C₁₈H₃₈ 50% to 50%, which is the temperature that programs the point of adjustment in air conditioning and heating equipment.

To achieve this in a proper range of cooling an area in the range of 4 to 8° C., which is the preservation or refrigeration range of perishable in several industries (in paraffin microencapsulated) through Tetradecane C₁₄H₃₀). In case that it is required to achieve a micro-encapsulated material with ability to retard fire (painting back fire retardant) can be used as material of phase change micro-encapsulation (PCM's), among others, the following hydrated salts: Calcium Chloride Hexahydrate CaCl₂6H₂O mixed in equal parts with KF3H₂O Trihydrate Potassium Fluoride are used for air conditioning. Lithium Chlorate Trihydrate LiClO₃3H₂O, can be indicated in case of use for cooling. With all the mentioned above, in addition to obtain a paint with air conditioning effect or temperature conservation in the interior of an enclosure, the paint achieves an insect repellent and optionally a fireproofing effects.

Even another object of the present invention is to provide a vinyl-acrylic paint, which in addition to the previous features has an adhesiveness, wash-ability, durability (over 6 years), coverage and protection of the surface covering.

### BRIEF DESCRIPTION OF THE INVENTION

It provides a water-based paint to be applied on a wide range of substrates such as glass, wood, plastic or metal surfaces, and substrates of material of construction such as plaster, drywall, concrete and cement. The composition of the paint does not change regardless of the substrate to which it will apply.

The invention also provides a novel and inventive method of elaborating a paint aqueous base; the method comprises a series of steps to apply in the order indicated, that includes the POWs which is difficult to insert due to its density and speed mixed times, that are of high relevance.

Thermal paint is formulated in the following way:

(a) In a kinetic disperser with propeller Cowles of variable speed starts dumping to a barrel, the first materials of the formula: water, dispersant additive, antifoam additive, coalescing additive, preventive moisturizers agents, and preventive agents (fungicide and bactericide), and a repellent additive at a speed of 1200 rpm rotation, or the necessary homogeneity;

(b) To the elements already mixed, and homogenized are added adjustment salts of basic pH between 8 and 9, and the mixture is dispersed until homogeneity;

(c) The microcapsules with change of phase material are slowly added in the form of dust and increase the speed of dispersion of the mixer to approximately 1,500 rpm until homogenized;

(d) It is remained in turmoil until the mixture is homogenized and thickened, avoiding at all times a stringy mass from forming, and it continues until it finishes incorporating the mentioned materials;

(e) Once it is homogeneous, it is added slowly and at a lower speed (approximately 1,200 rpm) regulating according to the optimal incorporation of titanium dioxide and pigments (in case of any) for a period of approximately 15 minutes, then apply a thickener and leave it under the mixer for about 45 minutes;

(f) Finally, vinyl-acrylic resin that is liquid is added and turns to increase the speed of the disperser approximately to 1,500 rpm being very careful of time and speed to avoid plasticizing or gelling of the mixture. If the paint is plasticized or gels, there is no way to rebuild it, and it has to be discarded.

It should be noted that in step c) is where the temperature properties will be given, while in part a) are added the materials that give the characteristics of repellency to insects and protection against moisture and bacteria. These additives are commonly used in the paint manufacturing.

A great technical difficulty that occurs in this process is to reach a suitable composition of homogeneous integration of the different components; especially the microcapsules or PCM's given in the case of paraffin, having a density less than 1 (usually of 0.8). The solution provided by the present invention is to prepare the paint in the order and described conditions mentioned above, avoiding its emulsification and the formation of lumps.

### Painting Manufacture Examples

The paint ingredients are exact portions of the following materials:

| % | COMPONENT | QUANTITY |
|---|---|---|
| 16.55 | Water | 1,655.0 (l) |
| 0.34 | Dispersant | 34.0 (l) |
| 0.25 | Antifoaming Agent | 25.0 (l) |
| 2.38 | Coalescing | 238.0 (l) |
| 0.35 | Moisturizing | 35.0 (l) |
| 9.84 | Pigments/Titanium Dioxide | 984.0 (kg) |
| 0.37 | PH Adjustment Salts | 37.0 (kg) |
| 0.37 | Preventive Additives Fungicides | 37.0 (l) |
| | And Bactericides | |
| 0.12 | Capsicum Oleoresin | 12.0 (kg) |
| 40.0 | Phase Change Material | 4,000 (kg) |
| 29.32 | Vinyl Acrylic Resin | 2932 (l) |
| 0.11 | Thickener | 11.0 (l) |

The optimal amount percentage of micro-encapsulate phase change material was obtained after subduing heat of fusion enthalpy measurement tests, several samples of paint made with different percentages of integration of microspheres with an approximately expected latent heat of 140-190 j/gr. The instrument of measurement used is called DSC, which it is a scanner for scanning increases in heat activity per unit of time. The obtained graphics determine the behavior of the sample. After several samples, the optimum percentage of phase change material micro encapsulated that the paint has to have, is comparatively obtained to achieve the best value of compensation of energy per unit area (e.g. square meter).

In addition, to all mentioned about, in order to verify the paint functioning as a temperature conservation element within an enclosure, measurements of consumption of kilo-watts/hour were made. On one hand, such measurements ware made once the paint was placed in the measurement area, and the same was done in a similar area, but without the novel paint of the invention.

The test was performed in venues built with the same material of equal dimensions and even the same geographical orientation and identical air conditioning equipment. Measurements were made under the same conditions and at the same time in both areas to be able to standardize savings of energy from external variables of temperature and thermal behaviors. Levels of savings were obtained by comparison between an area and the other in various weather conditions.

The advantage of this painting is the applied technology of phase change with greater energy efficiency than when it is performed mixing particles for example on boards, without having to use large amounts of phase change material to do so, in other words, achieving the same energy saving as in a flattened surface or on a panel, but with a surface thickness approximately 10 times lower, achieving with this technical advantage for more efficient use, requiring less amount of micro-particles per unit area and transportation of raw materials, for their application in enclosures and also commercial viability with this technology, commercially applied in buildings and places conditioned by automated external sources.

The micro-particles used in the present invention for air conditioning are based on fatty acids from vegetable and animal storers, as well as paraffinic storers as organic elements of phase change. Hydrated inorganic salts, as the Calcium Chloride Hexahydrate CaCl₂6H₂O can alternatively be used and mixed in equal parts with KF3H₂O Potassium Fluoride Trihydrate, also another mixtures of other hydrated salts can be used, depending on the thermal range sought or for use in refrigeration that are based on Lithium Chlorate Trihydrate, LiClO₃3H₂O.

Even before the present invention, the hydrated salts, in a liquid state, have not been mixed in the form of microcapsules, and for the same reason they could not be applied to paints. It is clear that encapsulation is indispensable, because without it, in a liquid state would lose its reversible capacity of change of phase. It would release the water molecules of the saline solution as soon as it would melt when changing to the physical state.

In a closed permanent environment, as in the case of the microcapsules used here, the effect of reversible change of physical state can indefinitely be repeated. On the other hand, there is a process to obtain a micro-encapsulation developed through a compound of starch, which is fragmented by gradual degradation and size programmed into the micro-encapsulation, therefore freeing, with a delayed effect, the powdered capsaicin contained in these microcapsules that are going to add to the formula the feature of insects repellency, to thermal and fireproof paint, with this it will have a triple benefit. In this mode the microencapsulated is not permanent.

1. Thermal fire retardant vinyl-acrylic paint water based that includes materials of phase change organic storers of fatty type acids of vegetal origin (oils of soy, coconut, stearic, lauric, among others) characterized because it also contains: Capsaicin, Oleoresin; animal fatty acids and plant storers; Tetradecaeno; Hexadecaeno; and Octadecaeno.

2. This paint, according to the claim 1,

3. This paint, according to claim 2, characterized because it also includes a dispersant additive, an antifoaming agent additive, a coalescing additive, wetting agents and at least one of a fungicide and bactericide additive.

4. This paint, according to the claim 3, characterized because Capsaicin is in a powder form and is micro-encapsulated through a compound based on starch, which is fragmented by gradual degradation and size programmed into the micro-encapsulation.

5. This paint according to claim 4, characterized because the microcapsules are hydrated salts.

6. Thermal fire retardant vinyl-acrylic paint, water base, having storers phase change materials characterized because they also include:
Oleoresin Capsaicin.

7. This paint according to claim 6, is characterized because the inorganic type phase change material may be among others lithium chlorate trihydrate LiClO₃3H₂O. Or it is characterized because the phase change material is one of the following hydrated salts: calcium chloride hexahydrate CaCl₂6H₂O mixed in equal parts with KF3H₂O potassium fluoride trihydrate.

8. A paint which includes:

| % | COMPONENT | QUANTITY |
|---|---|---|
| 16.55 | Water | 1,655.0 (l) |
| 0.34 | Dispersant | 34.0 (l) |
| 0.25 | Antifoaming Agent | 25.0 (l) |
| 2.38 | Coalescing | 238.0 (l) |
| 0.35 | Moisturizing | 35.0 (l) |
| 9.84 | Pigments/Titanium dioxide | 984.0 (kg) |
| 0.37 | PH Adjustment Salts | 37.0 (kg) |
| 0.37 | Preventive Additives Fungicides | 37.0 (l) |
| | and Bactericides | |
| 0.12 | Capsicum Oleoresin | 12.0 (kg) |
| 40.0 | Phase Change Material | 4,000 (kg) |
| 29.32 | Vinyl Acrylic Resin | 2932 (l) |
| 0.11 | Thickener | 11.0 (l) |

9. A process to prepare a fireproof thermal paint as described in claim 1 or vindication 6, characterized because it includes, in a variable speed disperser the following steps:
(a) Initiate the spill, to a barrel, of the first materials of the formula: water, dispersant additive, antifoam additive, coalescing additive, moisturizers agents and preventive additives, at a speed of 1200 rpm rotation or the necessary homogeneity;
(b) Already mixed and homogenized, salts of adjustment of basic pH between 8 and 9 are added and mixture disperses until it gets homogeneity;
(c) Add gradually the microcapsules with material of change of phase in the form of dust and increase the speed of dispersion of the mixer to approximately 1,500 rpm until gets homogeneity;
(d) Remains in turmoil until the mixture thickens and homogenizes, avoiding at all times a stringy mass from forming and it continues until it finishes incorporating the mentioned materials;
(e) Once homogeneous, it is added slowly and at a lower speed (approximately 1,200 rpm) regulating according to the optimal incorporation of titanium dioxide and pigments (in case of any) for a period of approximately 15 minutes and then apply a thickener and leave it under the mixer for about 45 minutes;
(f) Add liquid vinyl-acrylic resin by increasing the speed of the disperser to approximately 1,500 rpm where the plasticizing or gelling of the mixture should be avoided.

10. The process according to the claim 9, is characterized because in step a) an insect repellent additive is added.
